(19) United States
(12) Patent Application Publication
(10) Pub. No.: US 2023/0256720 A1
(43) Pub. Date: Aug. 17, 2023

(54) SANDWICH ELEMENT AND METHOD FOR PRODUCING A SANDWICH ELEMENT

(71) Applicant: Ingomar RITSCH, WorgI (AT)

(72) Inventor: Ingomar RITSCH, WorgI (AT)

(21) Appl. No.: 18/008,494

(22) PCT Filed: Mar. 4, 2021
(86) PCT No.: PCT/AT2021/060073

§ 371 Date: Dec. 6, 2022

(30) Foreign Application Priority Data
May 29, 2020 (AT) A 50471/2020

(51) Int. Cl. B32B 21/04; B32B 5/18; B32B 7/08; B32B 38/18

(52) U.S. Cl. CPC B32B 21/047; B32B 5/18; B32B 7/08; B32B 38/1825; B32B 2250/03; B32B 2250/40; B32B 2266/0228; B32B 2317/16; B32B 2325/00; B32B 2266/08

(57) ABSTRACT

The invention relates to a sandwich element with a central layer (10) made of a foamed filler material, preferably plastic foam, and outer layers, wherein the outer layers are made of pressure panels (2, 3), preferably flat pressure panels, and pressure panels lying opposite each other are clamped against each other by means of clamping elements (4) which pass through the central layer (10), thereby compressing the central layer (10). The invention additionally relates to a method for producing such a sandwich element and to a support, in particular a buoyant platform, which is made of such sandwich elements, including the process of producing such a support.

The invention relates to a sandwich element according to the preamble of Claim 1, a method of producing a sandwich element and a method of manufacturing a carrier, in particular a buoyant platform, from such sandwich elements, and a carrier, in particular a buoyant platform.

Such a sandwich element, which can in particular be used as a door leaf, can be found, for instance, in DE 1811544 U. In this application, an intermediate layer of foamed polystyrene is bonded, in particular adhesively bonded, to the two outer layers. Another similar sandwich element which has an improved flexural stability and can therefore in particular be used as a scaffold floor, is known, for instance, from DE 29606549 U. In this application, the increased flexural stability is achieved by a secure connection between the individual layers, which safely absorbs the shearing stresses.

The present invention now describes a different method for solving the task of increasing flexural stability of such sandwich elements and buoyant platforms formed by them, since frictional engagement or frictional connections between the intermediate layer and each outer layer are subject to limitations.

According to the invention, a flexural stability even increased substantially further of the sandwich element is achieved by the features of Claim 1.

By means of the tensioning elements extending through the intermediate layer, homogeneous compression of the filling material can be achieved over the entire surface of the pressure plates.

In a first preferred embodiment, the sandwich element is longitudinally cuboid and has one pressure plate each on the upper side and on the lower side. Compression of the intermediate layer can preferably be achieved and maintained by tensioning the pressure plates with respect to each other by means of tensioning elements extending through the intermediate layer. The tensioning elements can also be subsequently retensioned, if desired.

For manufacturing such a sandwich element, the invention envisages a method having the features of Claim 12.

The intermediate layer consists of foamed filling material. It has proven to be advantageous if the intermediate layer is made of an expanded thermoplast, preferably polystyrene. However, other foamed filling materials are conceivable as well, for instance foamed glass.

Straining screws are preferably used as tensioning elements connecting the upper and lower cover plates. Tensioning elements extending in parallel to the outer layers are preferably provided with ropes.

In another preferred embodiment, it is envisaged to manufacture the pressure plates from wooden materials, in particular from board plywood, plates which have been made water-resistant by a respective treatment being particularly suited.

Due to the materials used, the sandwich elements have a relatively low weight and can be employed as longitudinal supporting structures due to their high flexural stability. It is also possible to manufacture buoyant platforms, in particular for river vessels, by placing several sandwich elements adjacent to each other and connecting them horizontally by means of additional tensioning elements to form a large stable surface.

In the following, the invention will now be described using the enclosed Figures, without being limited thereto. In these Figures:

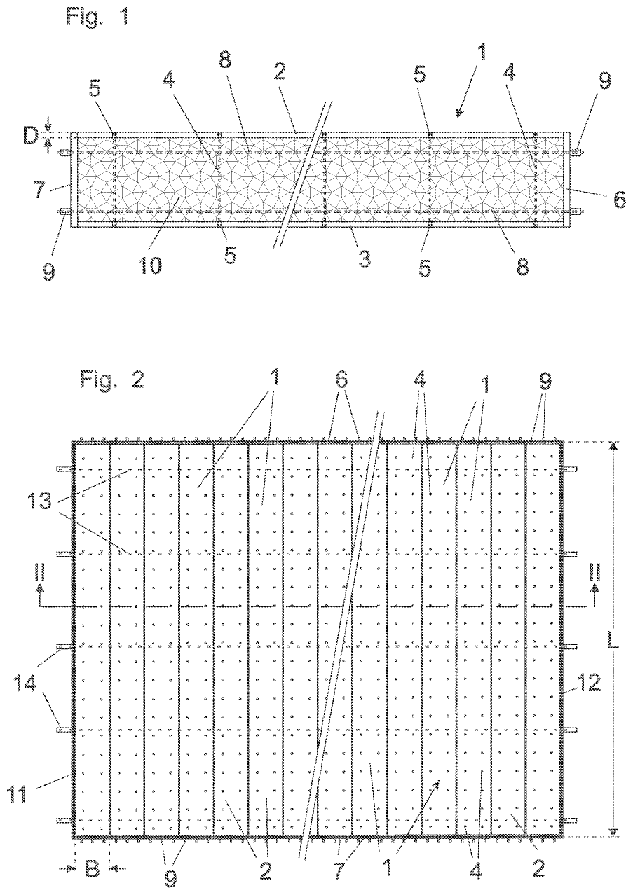

FIG. 1 is a schematic longitudinal section through a sandwich element according to the invention along line I-I of FIG. 2; and

FIG. 2 is a schematic top view of a platform manufactured of several sandwich elements according to FIG. 1, placed next to each other;

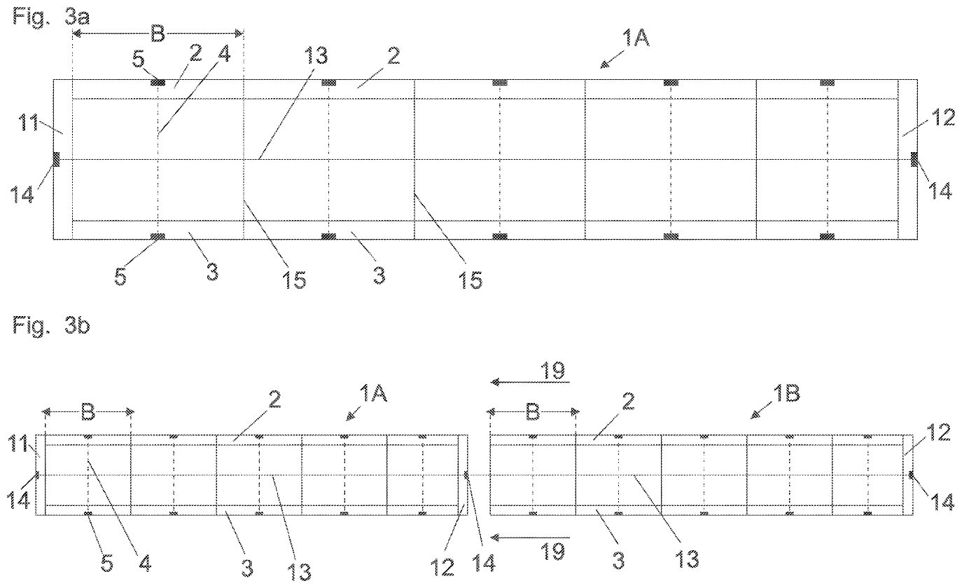

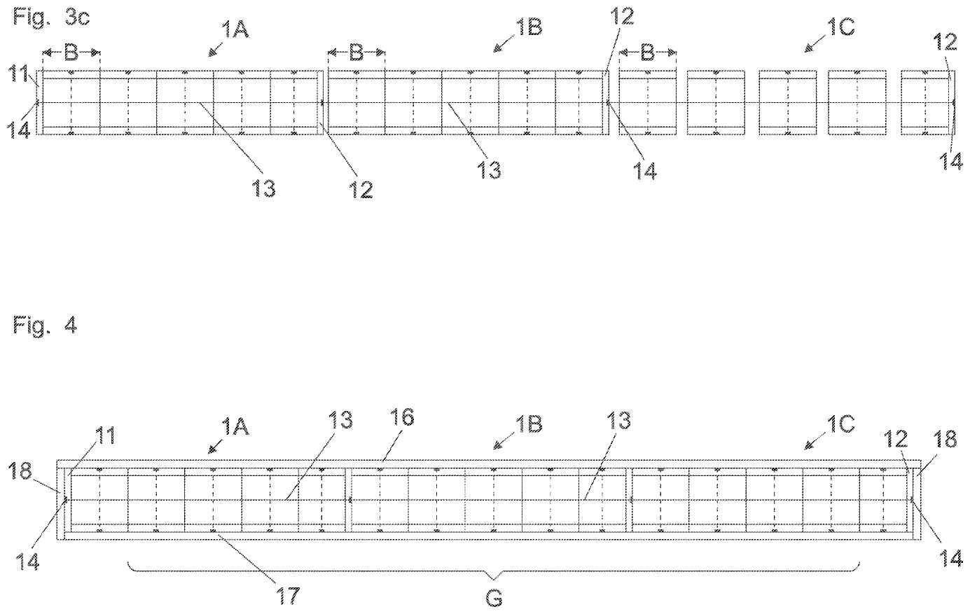

FIGS. 3a-3c are schematic sections along the lines II-II of FIG. 2;

FIG. 4 is a sectional view of an embodiment of a buoyant platform formed of several large surfaces.

A sandwich element (module) 1, especially in the form of a longitudinal strip, has an intermediate layer 10 which preferably consists of expanded polystyrene. The sandwich element 1 is provided with one pressure plate 2, 3 each on the upper and on the lower face. The two pressure plates 2, 3 are tensioned with respect to each other by vertical tensioning elements 4 which penetrate the intermediate layer 10, causing the intermediate layer 10 to be flattened or compressed and the flexural stability of the sandwich element 1 to be increased so that the sandwich elements can be used as load-bearing elements. The tensioning elements 4 each engage in tensioning nuts or strain anchors 5 on the outer faces of the pressure plates 2, 3. The tensioning elements 4 are schematically shown as individual rods or pulling bolts. Preferably, however, they extend through the intermediate layer 10 at slanting angles alternately, in the form of a trelliswork. The pressure plates 2, 3 advantageously consist of wooden materials, in particular of board plywood. The two end faces of the intermediate layer 10 can be covered by plates 6, 7 for protection against external influences.

As mentioned above, the individual sandwich element in FIG. 1 (module) is longitudinal, with its length L being multiple times, at least five times, larger than its width B. With this longitudinal implementation, “beams” can substantially be formed which can then be used to manufacture a buoyant platform, as FIG. 2 will show. The modular structure can help, due to the number of sandwich elements (modules) 1 used, to achieve a slight adaptation to the respective requirements (dimensions) of the desired platform.

The intermediate layer preferably consists of a thermoplast, preferably polystyrene, but it can also be made of other foamed filling materials, such as foamed glass.

The thickness D of the pressure plates 2, 3 is preferably between 1 cm and 30 cm and particularly preferably between 2 cm and 5 cm.

The length L of the pressure plates 2, 3 is preferably between 100 cm and 800 cm, particularly preferably between 150 cm and 600 cm.

The width B of the pressure plates is preferably between 20 cm and 80 cm, particularly preferably between 25 cm and 60 cm.

The abovementioned dimensions allow the manufacturing of stable buoyant platforms which can also support high loads, in particular vehicles.

The density of the filling material compressed between the pressure plates 2, 3 is preferably between 15 kg/m³ and 150 kg/m³. Due to this relatively low density, in combination with the wooden material of the pressure plates, a lower overall density and thus a high buoyancy and in the end a high load-bearing capacity can be achieved.

The invention further relates to a method of manufacturing a sandwich element. This method is characterized in that a dimensionally stable intermediate layer (10) is produced from a foamed filling material, preferably plastic, which is subsequently provided with a lower and an upper pressure plate (2, 3) and finally tensioned by means of tensioning elements (4) each of which penetrates the intermediate layer (10), with compression of the filling material between the mutually opposite pressure plates (2, 3).

That is, there is no intermediate space between the plates which is filled with foam after production, but instead one proceeds from a dimensionally stable intermediate layer consisting of a foamed filling material which is preferably an already largely cured plastic foam. Then, according to the invention, this intermediate layer is compressed by the pressure plates and the tensioning elements so as to increase the overall flexural rigidity of the entire sandwich element.

Preferably, it is envisaged to compress the intermediate layer by the pressure plates 2, 3 and the tensioning elements 4 to a volume between 1% and 80%, preferably between 10% and 50%, of the original, non-compressed volume.

FIG. 2 shows the usage of a plurality of strip-shaped or cuboid sandwich elements 1 which are arranged next to each other and interconnected at their non-covered longitudinal sides to form a platform. Such a platform is buoyant and can have a size of, for instance, 75 m×18 m. Due to increased flexural stability of the individual sandwich elements 1, it can also be used as a river vessel for transporting goods in river navigation. To interconnect the sandwich elements 1 arranged next to each other, again tensioning elements 13 and strain anchors 14 are used which are arranged on additional lateral pressure plates 11, 12 of the platform so that the directly adjacent intermediate layers 10 of the sandwich elements 1 are also compressed in this direction between the pressure plates 11, 12. The horizontal tensioning elements 13 are preferably formed by tensioning ropes or the like.

FIGS. 3a through 3c show how the ropes 13 can help to form larger units from individual modules by lateral joining and tensioning; finally, in particular, a buoyant platform.

The individual sandwich elements are joined at their abutting edges 15; the ropes 13 can then be tensioned by means of tensioning elements 14, resulting in a stable complete construction unit.

The FIG. 3a substantially corresponds to the FIG. 2, except for the number of sandwich elements.

Starting from such an assembly of the five sandwich elements in FIG. 3a, it is possible, as shown in FIG. 3b, to join, in the direction 19 of the arrow, an additional group of five elements by the tensioning of ropes 13. One continuous rope can be used here. However, it is also possible to attach a separate rope 13 to the right-hand plate 12 of the supporting (buoyant) large surface 1A and tighten this rope by means of the tensioning element 14 from the plate 12 on the very right of the large surface 1B.

FIG. 3c shows how an additional group of five sandwich elements can be added. This can also be done by attaching individual sandwich elements which are only tensioned when added to the other sandwich elements. It is also possible, however—as shown in FIG. 3b—to form assemblies of five sandwich elements each in advance. This results in a stable larger unit G which can be used as a buoyant platform.

This unit G can then be assembled to form a finished, buoyant platform by the addition of other components, as shown in the embodiment according to FIG. 4. On the top, there is a closed track 16; on the bottom, a sliding plate 17. These two components (track 16 and lower sliding plate 17) preferably have a large surface and cover the abutting edges between the individual modules/sandwich elements.

Also, a protective plate 18 can be provided on each side to prevent damage when the buoyant platform collides for instance with dock components or with other buoyant platforms.

As can be seen in FIG. 3, the filling material has protective plates on all sides even without the track 16 and the sliding plate 17. In FIG. 4, this protection is even doubled, namely by the parts 16, 17 and 18.

As already mentioned, the invention is particularly suited for constructing buoyant platforms. Due to the low density of the filling material and the preferably buoyant pressure plates, a low overall density and thus a high load-bearing capacity can be achieved, as well as a high rigidity due to the embodiment according to the invention. Thus, vehicles (self-driven or pushed) can also be loaded onto these buoyant platforms. It is also possible to load other goods.

In addition to buoyant platforms, other modular carriers can also be constructed from the sandwich elements according to the invention, for instance lightweight bridges or other lightweight supports.

1. Sandwich element having an intermediate layer consisting of a foamed filling material, preferably plastic foam, as well as outer layers; wherein the outer layers are formed by—preferably planar—pressure plates and wherein mutually opposite pressure plates are tensioned with respect to each other with compression of the intermediate layer by means of straining screws penetrating through the intermediate layer, wherein the intermediate layer is made of an expanded thermoplast and is flattened the pressure plates.

2. Sandwich element according to claim 1, wherein the sandwich element is longitudinal and cuboid and wherein the pressure plates are arranged at least on the upper face and on the bottom face.

3. Sandwich element according to claim 1, wherein the length of the sandwich element is a multiple of, at least five times as large as, its width.

4. (canceled)

5. Sandwich element according to claim 1, wherein the pressure plates are made of wooden materials.

6. Sandwich element according to claim 1, wherein the intermediate layer consists of polystyrene.

7. Sandwich element according to claim 1, wherein the thickness of the pressure plates is between 1 cm and 30 cm, preferably between 2 cm and 15 cm.

8. Sandwich element according to claim 1, wherein the length of the pressure plates is between 100 cm and 800 cm, preferably between 150 cm and 600 cm.

9. Sandwich element according to claim 1, wherein the width of the pressure plates is between 20 cm and 80 cm, preferably between 25 cm and 60 cm.

10. Sandwich element according to claim 1, wherein the density of the filling material compressed between pressure plates is between 15 kg/m³ and 150 kg/m³.

11. Sandwich element according to claim 1, wherein the filling material of the intermediate layer consists of a closed-cell foam—preferably plastic foam.

12. Method of producing a sandwich element according to claim 1, wherein a dimensionally stable intermediate layer is produced from a foamed filling material, preferably plastic, which subsequently is provided with a lower and an upper pressure plate and which is finally tensioned by means of tensioning elements each penetrating through the intermediate layer with compression of the filling material between the mutually opposite pressure plates.

13. Method according to claim 12, wherein the intermediate layer is compressed by the pressure plates and the tensioning elements to a volume between 1% and 80%, preferably between 10% and 50%, of the original non-compressed volume.

14. Method of producing a carrier, in particular a buoyant platform, in particular for river vessels, wherein several sandwich elements according to claim 1 are placed adjacent to one another, provided with end-face pressure plates and connected by horizontal tensioning elements to form one carrier, in particular one large load-bearing surface.

15. Method according to claim 14, wherein a carrier, in particular a large load-bearing surface, is combined with at least one other carrier, in particular another large load-bearing surface to form a larger unit, in particular a buoyant platform, by lateral compression by means of tensioning elements on end-face pressure plates.

16. Method according to claim 14, wherein the horizontal tensioning elements have ropes.

17. Carrier, in particular buoyant platform, in particular manufactured with a method according to claim 14.

18. Sandwich element according to claim 1, wherein the sandwich element has plates on its end faces which are connected by elements passing through the intermediate layer, wherein the elements passing through the intermediate layer are preferably devised as ropes.
